(19) United States
(12) Patent Application Publication
(10) Pub. No.: US 2026/0091751 A1
(43) Pub. Date: Apr. 2, 2026

(54) STEERING DEVICE

(71) Applicant: TOYODA GOSEI CO., LTD., Kiyosu-shi (JP)

(72) Inventors: Kazuma Muramatsu, Kiyosu-shi (JP); Akitoshi Naganawa, Kiyosu-shi (JP); Itsuhiko Hirota, Kiyosu-shi (JP); Kikka Ban, Kiyosu-shi (JP)

(21) Appl. No.: 19/293,502

(22) Filed: Aug. 7, 2025

(30) Foreign Application Priority Data
Sep. 27, 2024 (JP) 2024-169226

(51) Int. Cl. B60R 21/2165; B60Q 3/283; B60Q 3/80

(52) U.S. Cl. CPC B60R 21/21656; B60Q 3/283; B60Q 3/80

(57) ABSTRACT

A steering device includes a pad disposed on an upper side of a boss portion and an electronic component disposed on the pad. The pad includes a ceiling wall portion disposed on a driver side and a peripheral wall portion extending in a tubular shape from an area near a peripheral edge of the ceiling wall portion. In the peripheral wall portion, a slit that allows a lead wire to be inserted is formed by cutting out the peripheral wall portion from a tip end side, the lead wire extending from a disposition area of the electronic component in the ceiling wall portion and passing through a back surface side of the ceiling wall portion.

### CROSS REFERENCE TO RELATED APPLICATION

The present application claims priority from Japanese Patent Application No. 2024-169226 of Muramatsu et al., filed on September 27, 2024, the entire disclosures of which are incorporated herein by reference.

### BACKGROUND

### 1. TECHNICAL FIELD

The present disclosure relates to a steering device having a configuration in which an electronic component is installed on a pad disposed on an upper side of a boss portion.

### 2. DESCRIPTION OF RELATED ART

Conventionally, WO 2023/163325 A discloses a steering device. In a conventional steering device, as an electronic component, a decorative body (emblem) that can emit light at a predetermined time is installed on a ceiling wall portion disposed on a driver side of a pad. In this steering device, a lead wire extending from a back surface side of a disposition area of the decorative body in the ceiling wall portion is inserted into an insertion opening formed in a peripheral wall portion extending from a peripheral edge of the ceiling wall portion in the pad to protrude to the outside of the pad. In the conventional steering device, the insertion opening is formed by cutting out the peripheral wall portion in a rectangular shape. The lead wire is electrically connected to a control device on a vehicle body side using a connector provided on a tip end side of the lead wire.

However, the lead wire needs to be inserted into the insertion opening together with the connector provided on the tip end side, and an outer shape of the connector on the tip end side is usually set larger than that of the lead wire. The insertion opening is formed to be opened in a rectangular shape in the conventional steering device, but it is preferable to set the opening area as small as possible. Therefore, the insertion opening is set to a size almost enough to allow insertion of the connector, and work of inserting the connector into the insertion opening from the inside of the pad (work of protruding the lead wire to the outside of the pad) is not easy.

### SUMMARY

A steering device of the present disclosure includes:

a pad disposed on an upper side of a boss portion;

an electronic component disposed on the pad and electrically connected to a control device provided on a vehicle body side, in which

the pad includes a ceiling wall portion disposed on a driver side and a peripheral wall portion extending in a tubular shape from an area near a peripheral edge of the ceiling wall portion, and

in the peripheral wall portion, a slit that allows a lead wire to be inserted is formed by cutting out the peripheral wall portion from a tip end side, the lead wire extending from a disposition area of the electronic component in the ceiling wall portion and passing through a back surface side of the ceiling wall portion.

### BRIEF DESCRIPTION OF THE DRAWINGS

FIG. 1 is a plan view of a steering wheel (steering device) according to an embodiment of the present disclosure;

FIG. 2 is a schematic sectional view of the steering wheel according to the embodiment, and illustrates a portion II-II in FIG. 1;

FIG. 3 is a plan view of an airbag device in the steering wheel according to the embodiment;

FIG. 4 is a bottom view of the airbag device of FIG. 3;

FIG. 5 is a rear view of the airbag device of FIG. 3 (a view of the airbag device as viewed from the front when the airbag device is mounted on a vehicle);

FIG. 6 is a schematic enlarged longitudinal sectional view of the airbag device of FIG. 3 on a front-rear direction side;

FIG. 7 is a schematic enlarged longitudinal sectional view of the airbag device of FIG. 3 on a left-right direction side;

FIG. 8 is a schematic perspective view of a pad in the steering wheel according to the embodiment;

FIG. 9 is a partially enlarged view illustrating a slit provided in a side wall portion of the pad; and

FIG. 10 is a partially enlarged sectional view schematically illustrating a state in which a lead wire is inserted into a slit provided in a pad in the steering wheel according to the embodiment.

### DESCRIPTION OF THE PREFERRED EMBODIMENTS

Preferred embodiments of the present invention are described below with reference to the accompanying drawings. However, the invention is not limited to the embodiments disclosed herein. All modifications within the appended claims and equivalents relative thereto are intended to be encompassed in the scope of the claims.

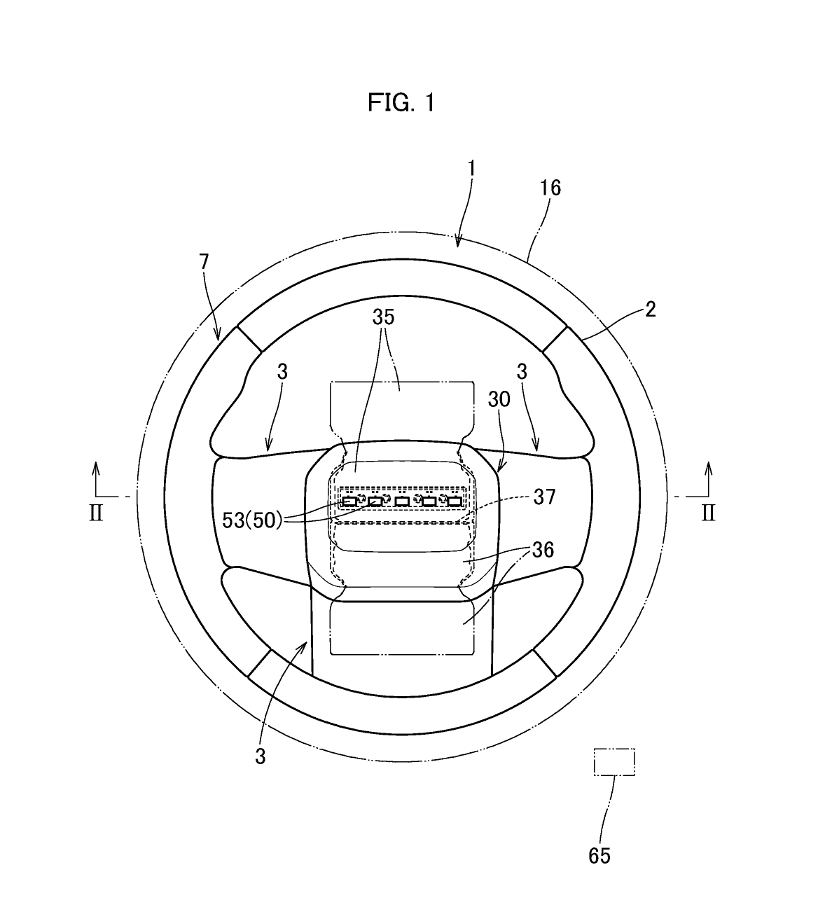

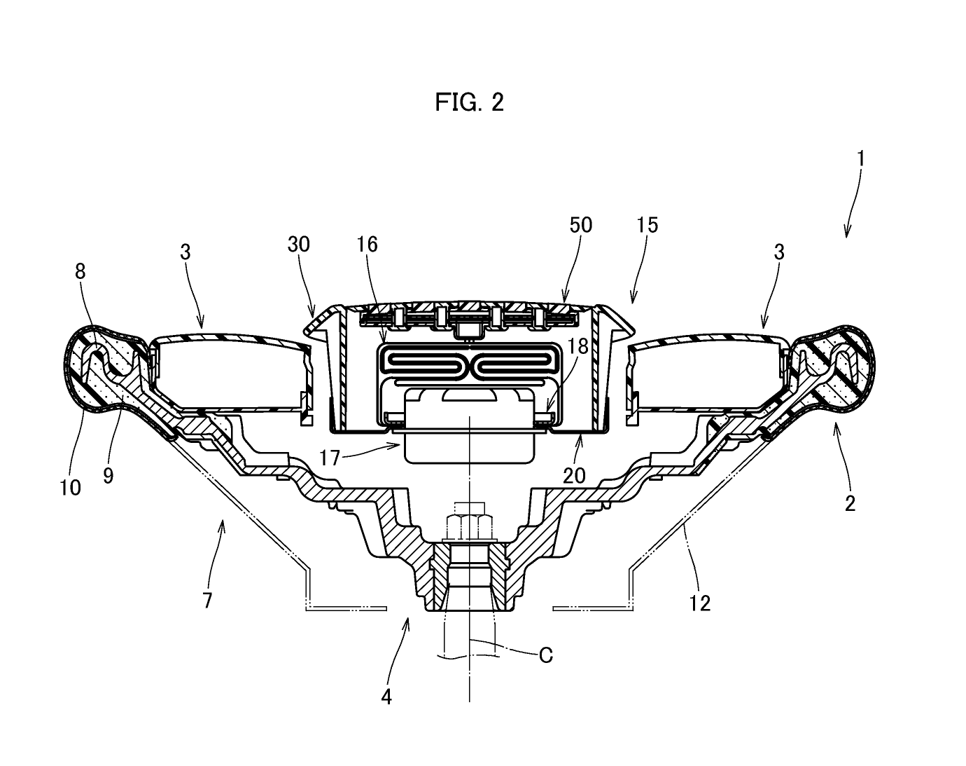

Hereinafter, an embodiment of the present disclosure will be described with reference to the drawings. In the embodiment, as a steering device, a steering wheel 1 including an annular ring portion 2 (grip portion) will be taken as an example and described. In the case of the embodiment, as illustrated in FIG. 1, the steering wheel 1 includes the annular ring portion 2 gripped at the time of rotational steering, a boss portion 4 disposed substantially at the center of the ring portion 2, a plurality of (3 in the case of the embodiment) spoke portions 3 connecting the ring portion 2 and the boss portion 4. As illustrated in FIG. 2, the steering wheel 1 includes, as components, a steering wheel body 7 and an airbag device 15 installed above the boss portion 4.

In the present specification, front-rear, upper-lower, and left-right directions are based on the straight advancing steering state of the steering wheel 1 mounted on the vehicle unless otherwise specified. Specifically, a direction along a rotation center axis C (see FIG. 2) of the ring portion 2 is defined as the upper-lower direction, a direction orthogonal to the rotation center axis C of the ring portion 2 and along the front-rear direction of the vehicle is defined as the front-rear direction, and a direction orthogonal to the rotation center axis C of the ring portion 2 and along the left-right direction of the vehicle is defined as the left-right direction.

As shown in FIG. 2, the steering wheel body 7 includes: a core metal 8 installed so as to couple the ring portion 2, the boss portion 4, and the spoke portions 3 to one another; a covering layer 9 covering the core metal 8 around portions of the ring portion 2 and the spoke portions 3; a skin layer 10 covering the outer peripheral side of the covering layer 9; and a lower cover 12 covering a lower surface side of the boss portion 4. The core metal 8 is made of metal such as an aluminum alloy or the like. The covering layer 9 is formed of a soft foam material such as foamed polyurethane. The skin layer 10 is formed of a synthetic resin sheet body or leather such as natural leather, synthetic leather, or artificial leather. The lower cover 12 is indicated by the two-dot chain line without being illustrated in detail, and is made of a synthetic resin.

As illustrated in FIGS. 2 to 7, the airbag device 15 includes: an airbag 16 folded and stored; an inflator 17 that supplies an inflation gas to the airbag 16; a pad 30 (airbag cover) installed on an upper side of the boss portion 4 and covering the folded airbag 16; a decorative body 50 serving as an electronic component provided on the pad 30; a bag holder 20 holding the airbag 16, the inflator 17, and the pad 30; and a retainer 18 for attaching the airbag 16 and the inflator 17 to the bag holder 20.

The airbag 16 has a bag shape formed of a flexible sheet body. Although not illustrated in detail, the airbag 16 has a substantially disk shape that can cover substantially the entire surface of an upper surface of the ring portion 2 when the airbag 16 is completely inflated with the inflation gas flowed into the airbag 16 (see the two-dot chain line in FIG. 1).

The inflator 17 includes a substantially cylindrical main body portion 17a and a flange 17c protruding from an outer peripheral surface of the main body portion 17a. A plurality of gas discharge ports 17b for discharging the inflation gas are provided in an upper portion of the main body portion 17a. Although not illustrated in detail, the inflator 17 is also electrically connected to a control device 65.

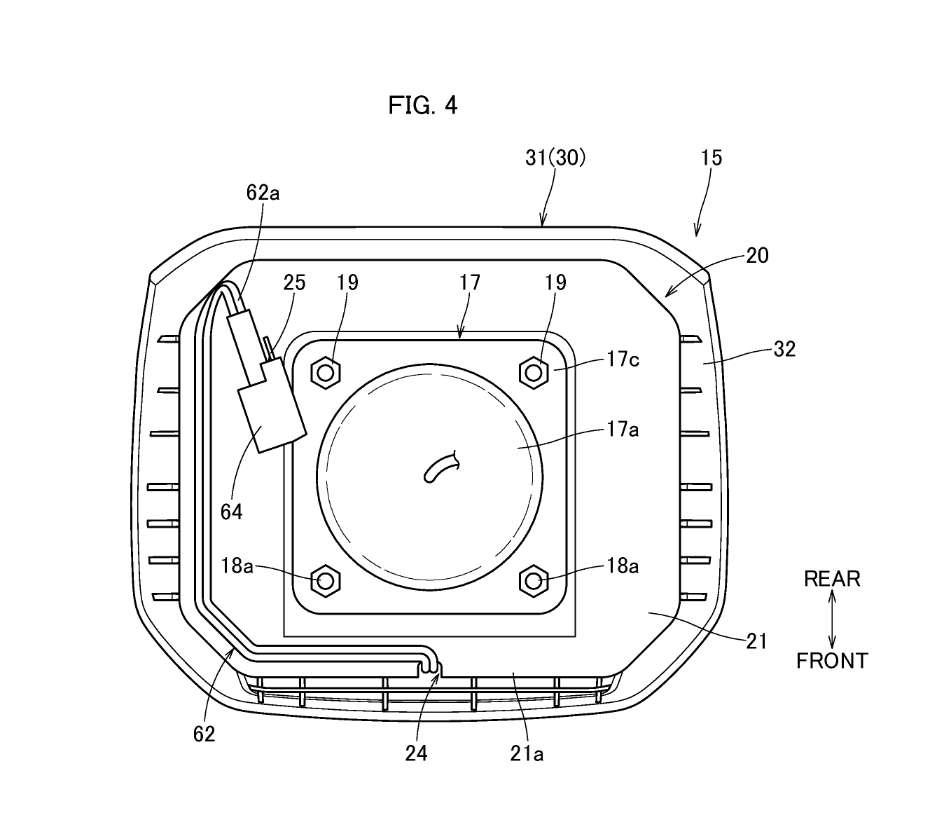

The retainer 18 is formed of a substantially rectangular-ring-shaped sheet metal, and includes bolts 18a (see FIG. 4) at four corners. The retainer 18 is installed in the airbag 16, and attaches the airbag 16 and the inflator 17 to the bag holder 20. Although not illustrated in detail, the bolts 18a of the retainer 18 protrude downward. These bolts 18a sequentially pass through the airbag 16, a bottom wall portion 21 described later of the bag holder 20, and the flange portion 17c of the inflator 17, and protrude from the flange portion 17c. In this state, nuts 19 (see FIG. 4) are fastened to the respective bolts 18a.

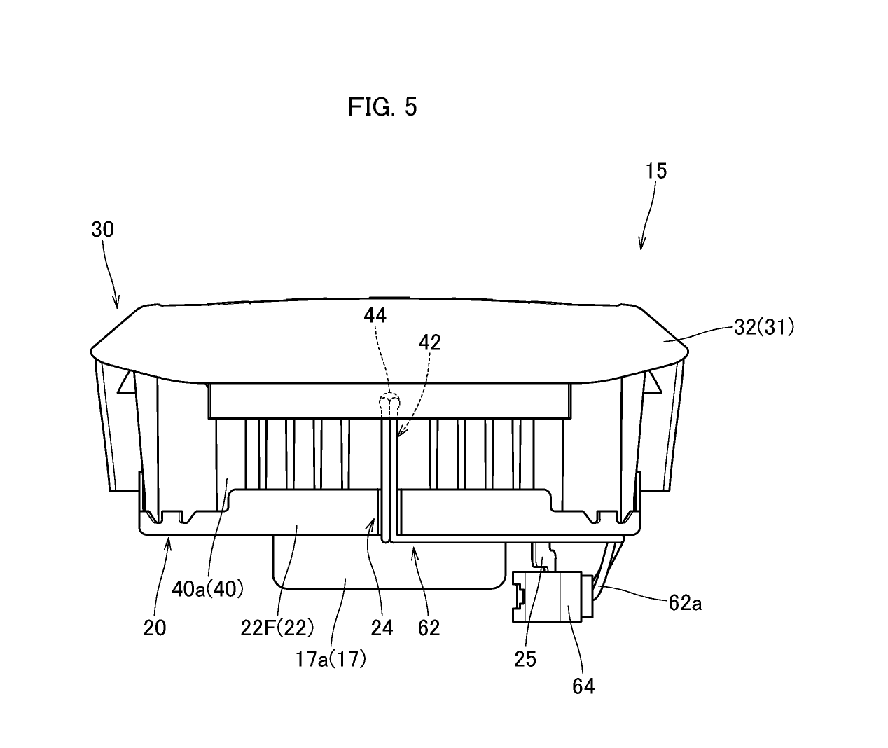

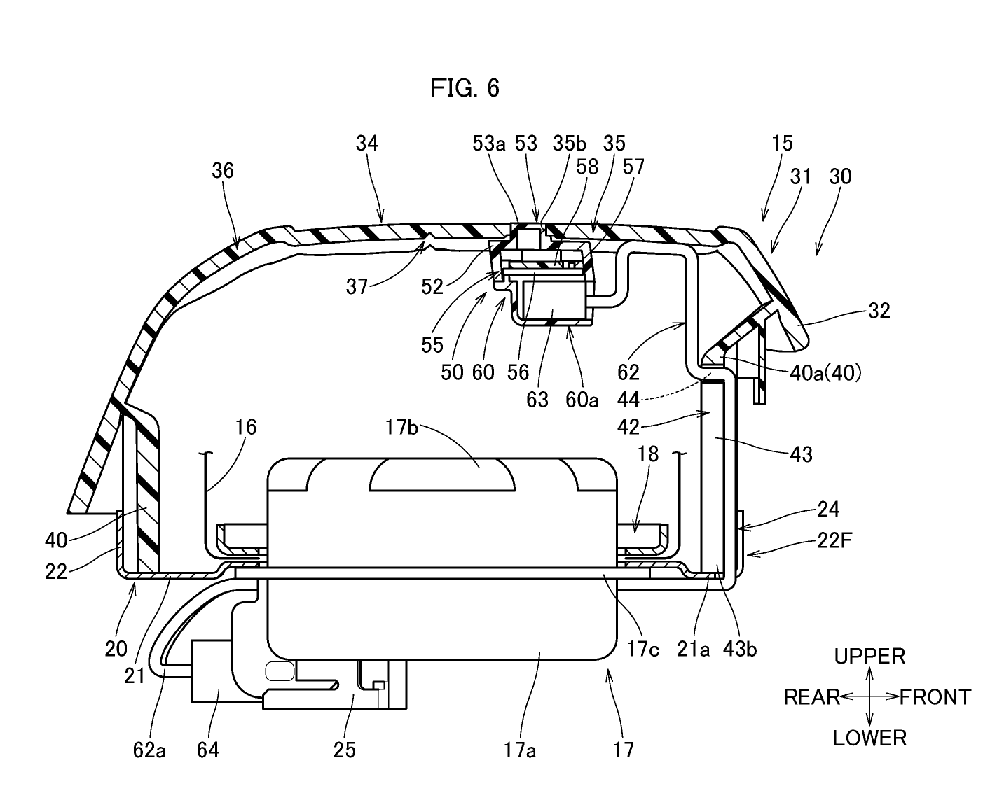

In the embodiment, the bag holder 20 is formed of sheet metal. As illustrated in FIG. 2, the bag holder 20 is a member that holds the airbag 16, the inflator 17, and the pad 30 and attaches the airbag device 15 to the steering wheel body 7 side using a horn switch unit (not illustrated). Specifically, as illustrated in FIGS. 4, 6, and 7, the bag holder 20 includes the bottom wall portion 21 having a substantially rectangular shape, and a side wall portion 22 provided so as to extend upward from a peripheral edge of the bottom wall portion 21. The airbag 16 and the inflator 17 are attached to the bottom wall portion 21 using the retainer 18. The bag holder 20 holds the pad 30 by coupling a predetermined portion of the side wall portion 22 to a peripheral wall portion 40 of the pad 30 using a rivet or the like (not illustrated). Specifically, four side wall portions 22 are arranged on the outer peripheral edge of the bottom wall portion 21 so as to extend upward from areas excluding the areas near the four corners. Each of the side wall portions 22 is located on the outer peripheral side of the peripheral wall portion 40 of the pad 30. In the bag holder 20 of the embodiment, an insertion recess 24 into which a lead wire 62 to be described later extending from the decorative body 50 installed on the pad 30 can be inserted is formed substantially at a center in the left-right direction of a side wall portion 22F at the front covering the front of the peripheral wall portion 40. Specifically, the insertion recess 24 is formed so as to be continuously cut out from an upper edge side of the side wall portion 22F to an area on a front edge 21a side of the bottom wall portion 21 (see FIGS. 4 and 5). Further, in the case of the embodiment, on a lower surface side of the bottom wall portion 21, a locking protruding piece 25 that can lock a connector 64 installed on a tip end 62a side of the lead wire 62 is formed so as to protrude downward (see FIGS. 5 and 6). Specifically, the locking protruding piece 25 is provided on a rear left end side of the bottom wall portion 21.

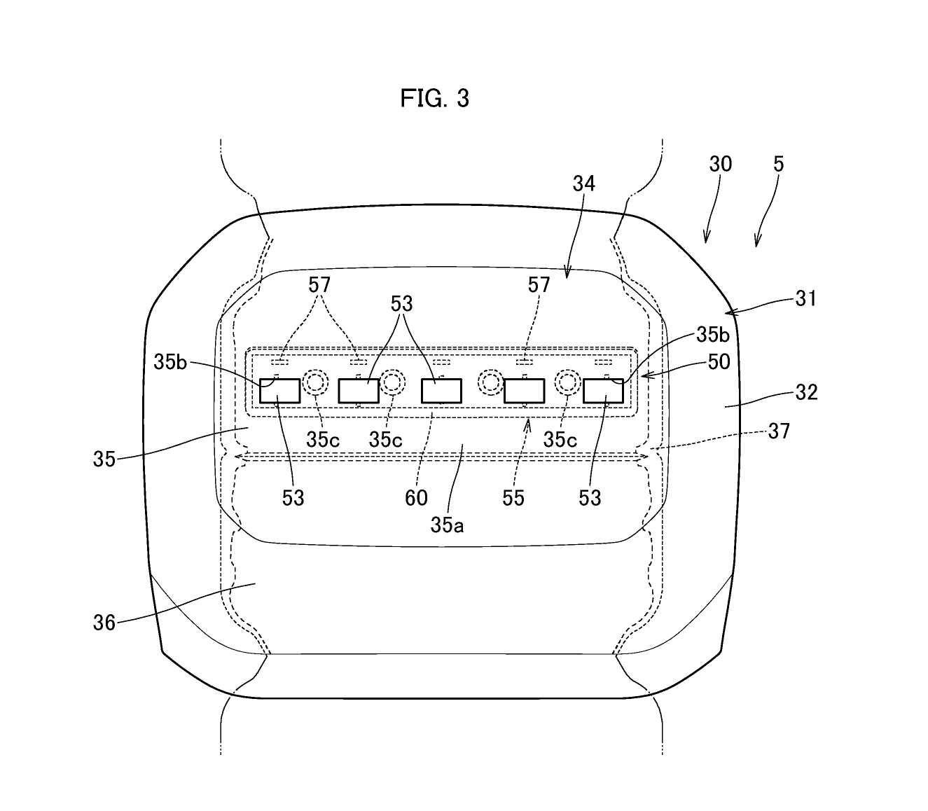

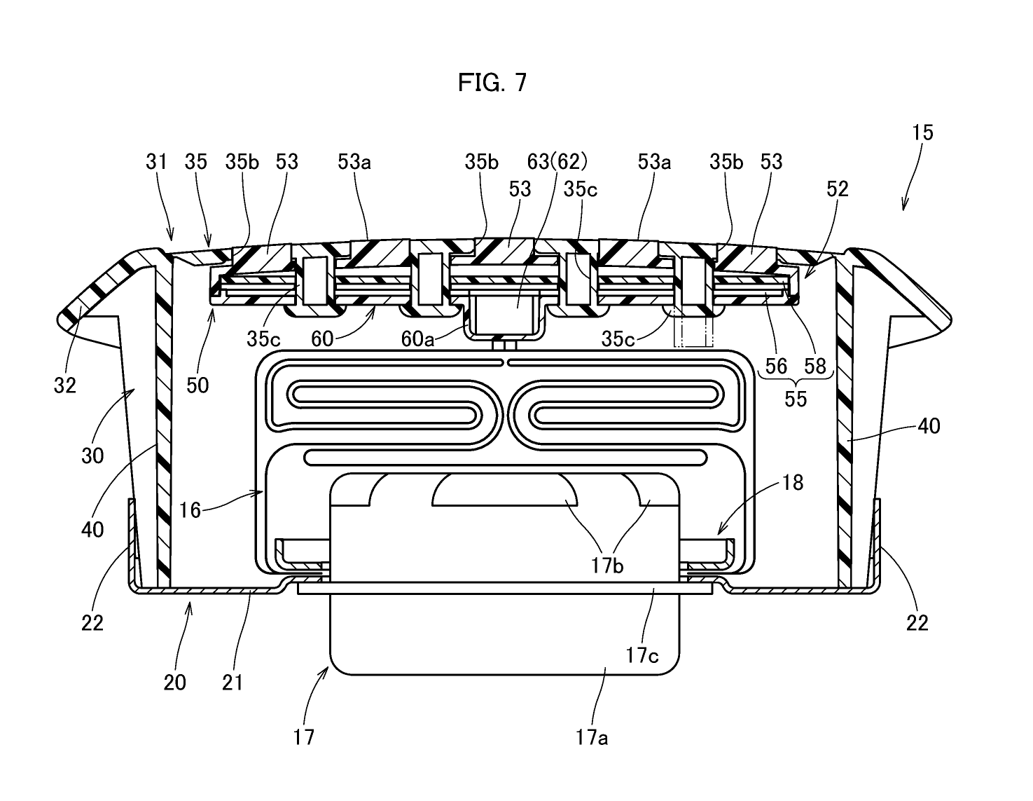

The pad 30 is disposed on the upper side of the boss portion 4, and is configured to be able to cover from an upper side to a side of the folded airbag 16 as illustrated in FIGS. 6 and 7. The pad 30 is made of a soft synthetic resin, and is made of a polyolefin-based thermoplastic elastomer (TPO) in the embodiment. Specifically, the pad 30 is formed using TPO colored in a dark color such as black as a base material. The pad 30 includes a ceiling wall portion 31 and the peripheral wall portion 40 extending in a tubular shape from an area near a peripheral edge of the ceiling wall portion 31 (see FIGS. 3 and 6 to 8). The ceiling wall portion 31 is disposed above on the driver side and covers the upper side of the folded airbag 16. The peripheral wall portion 40 covers the front, rear, left, and right sides of the folded airbag 16.

The ceiling wall portion 31 includes a door arrangement portion 34 including an area inside the peripheral wall portion 40 and a peripheral edge portion 32 including an area outside the peripheral wall portion 40. A front door portion 35 that opens forward and a rear door portion 36 that opens rearward are arranged in the area of the door arrangement portion 34 (see FIGS. 3 and 6). Around the front door portion 35 and the rear door portion 36, a breakable portion 37 that can be broken when the airbag 16 is inflated is provided. In the embodiment, the breakable portion 37 is formed by cutting out the ceiling wall portion 31 from a back surface side. Specifically, the breakable portion 37 is configured by continuously arranging notches having a V-shaped section (see FIG. 6).

In the ceiling wall portion 31, the decorative body 50 serving as an electronic component is installed on the front door portion 35. In the case of the embodiment, as illustrated in FIGS. 3, 6, and 7, the decorative body 50 is installed in an area on the back surface side on a rear edge 35a side of the front door portion 35, the area having a wide width in the left-right direction. Through holes 35b and coupling protrusions 35c are formed in the front door portion 35 (see FIGS. 6 and 7). The through holes 35b are formed so as to allow respective protruding portions 53 to pass through, the protruding portions 53 being formed on a surface (upper surface) side of a main body portion 52 described later in the decorative body 50. Each of the through holes 35b is formed to be opened corresponding to an outer shape of the corresponding protruding portion 53, and in the embodiment, the outer shape viewed from the upper side is a substantially rectangular shape, and five through holes 35b are aligned in the left-right direction (see FIGS. 3 and 7). The coupling protrusions 35c are portions for coupling the decorative body 50 to the pad 30. As illustrated in FIG. 3, the coupling protrusions 35c are arranged at four locations between the protruding portions 53 (between the through holes 35b) when the pad 30 is viewed from above. These coupling protrusions 35c are disposed so as to penetrate the entire decorative body 50 installed on the back surface side of the front door portion 35 such that the protruding portions 53 pass through the respective through holes 35b. Then, by melting a lower end side of each of the coupling protrusions 35c protruding from a holding member 60, to be described later, of the decorative body 50, the coupling protrusion 35c couples the decorative body 50 to the pad 30 (front door portion 35). An outer shape of the coupling protrusion 35c before melting is a round tubular shape as indicated by the two-dot chain line in FIG. 7.

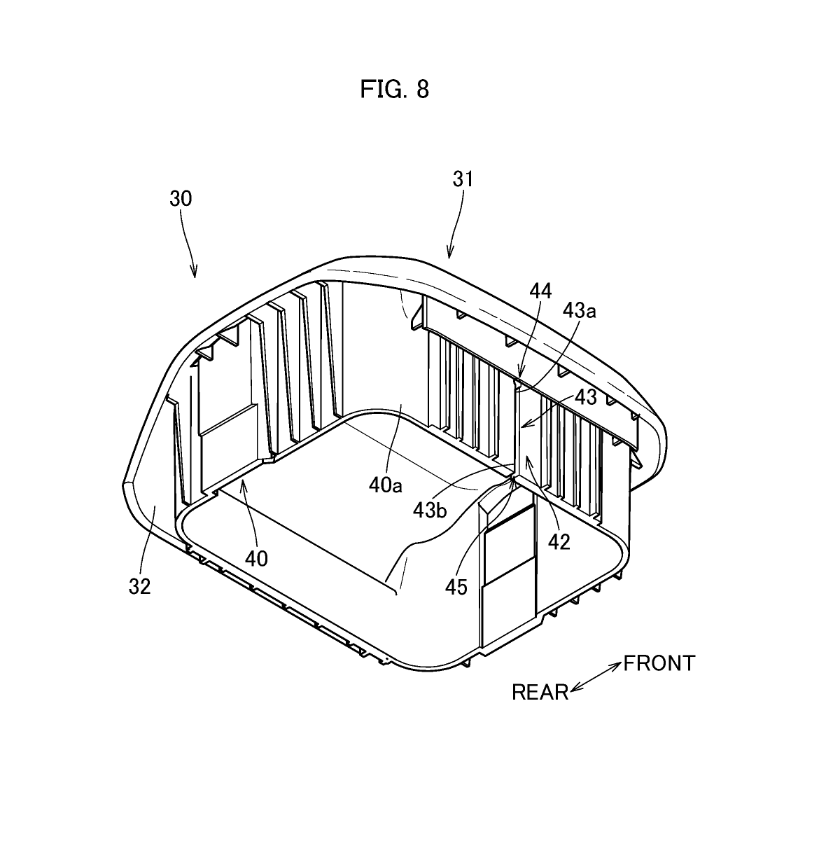

In the case of the embodiment, as illustrated in FIG. 8, the peripheral wall portion 40 has a rectangular tubular shape, and a tip end surface thereof is positioned in the vicinity of an upper surface of the bottom wall portion 21 in the bag holder 20. Further, the outer peripheral side near the tip end of the peripheral wall portion 40 is covered with the side wall portion 22 of the bag holder 20 (see FIGS. 6 and 7). In the peripheral wall portion 40, as illustrated in FIGS. 6 and 8, a slit 42 is formed in a front portion 40a which is a front area (area covering the front of the airbag 16) in the vicinity of a side serving as a hinge of the front door portion 35 when the front door portion 35 is opened.

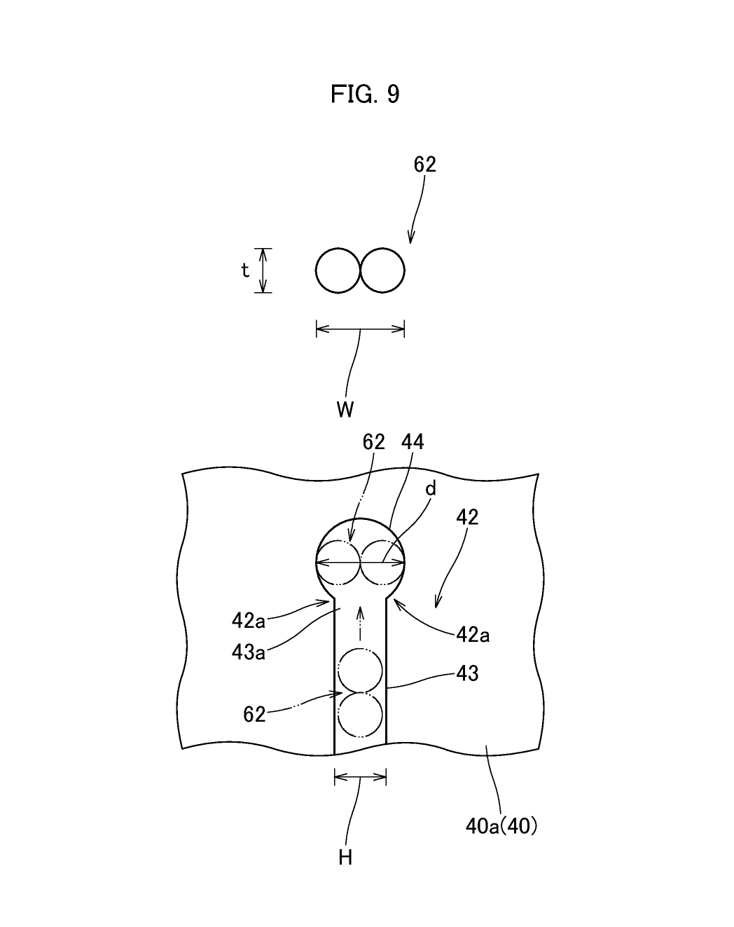

The slit 42 is for inserting the lead wire 62 extending from the decorative body 50, and is formed to extend along the upper-lower direction so as to cut out the front portion 40a of the peripheral wall portion 40 from a lower end side (tip end side) (see FIG. 8). Specifically, the slit 42 is formed at a position substantially at the center in the left-right direction of the front portion 40a. In detail, in the embodiment, the slit 42 is formed over substantially the entire area in the upper-lower direction of the peripheral wall portion 40 so that an upper end of the slit 42 is disposed at a position in the vicinity of a lower edge of the peripheral edge portion 32 in the ceiling wall portion 31. A round hole portion 44 cut out in a circular shape is provided on the upper end side of the slit 42. That is, as illustrated in FIGS. 8 and 9, the slit 42 includes: a general portion 43 which is cut out in a groove shape so as to open on a lower end 43b side (an opening 45 is provided on a lower end 43b side); and the round hole portion 44 formed on an upper end 43a side of the general portion 43 so as to be continuous from the general portion 43. An inner diameter dimension d of the round hole portion 44 is set larger than an opening width dimension H of the general portion 43 (see FIG. 9). In the embodiment, as illustrated in FIG. 9, the lead wire 62 has a flat shape in which two linear bodies are arranged side by side. Specifically, the opening width dimension H of the general portion 43 is set slightly larger than a thickness dimension t of the lead wire 62. The opening width dimension H of the general portion 43 is set smaller than a width dimension W of the lead wire 62. That is, the opening width dimension H of the general portion 43 is set to a dimension that allows the lead wire 62 to be slidable when the lead wire 62 is inserted in the direction along the width direction of the lead wire 62 (see the two-dot chain lines in FIG. 9). The inner diameter dimension d of the round hole portion 44 is set slightly larger than the width dimension W of the lead wire 62. The inner diameter dimension d of the round hole portion 44 is set to a dimension that allows the lead wire 62 to be inserted even in the direction along the thickness direction (see FIG. 9). That is, the lead wire 62 inserted through the general portion 43 and inserted into the round hole portion 44 is disposed in a rotated state so as to change the direction (substantially orthogonal to the general portion 43) in the round hole portion 44. In such a state, the lead wire 62 is restricted from entering the general portion 43 again. In the slit 42 of the embodiment, as illustrated in FIG. 9, areas of a peripheral edge of the general portion 43 in the vicinity of the round hole portion 44 constitutes retaining portions 42a and 42a that can prevent the lead wire 62 (specifically, the lead wire 62 disposed to be substantially orthogonal to the general portion 43) inserted therein from coming off.

The decorative body 50 serving as an electronic component is electrically connected to the control device 65 provided on a vehicle body side, and can emit light at a predetermined time. The decorative body 50 is installed in an area of the front door portion 35 in the ceiling wall portion 31 of the pad 30. Specifically, as described above, the decorative body 50 is installed in the area on the back surface side on the rear edge 35a side of the front door portion 35, the area having a wide width in the left-right direction. As illustrated in FIG. 3, an outer shape of the decorative body 50 viewed from the upper-lower direction side is an elongated shape extending along the left-right direction. Furthermore, the decorative body 50 is configured such that the main body portion 52, a light source portion 55, and the holding member 60 are stacked (see FIGS. 6 and 7). In the case of the embodiment, as described above, the protruding portions 53 alone of the main body portion 52 in the decorative body 50 are exposed on the surface side of the pad 30 (see FIGS. 3, 6, and 7). Although a reference symbol is not assigned, a through hole through which the coupling protrusion 35c protruding from the back surface side of the front door portion 35 in the pad 30 can pass are formed in each of the main body portion 52, a light guide 58 and a substrate 56, which will be described later, in the light source portion 55, and the holding member 60.

The main body portion 52 has a substantially rectangular plate shape having a wide width in the left-right direction. The protruding portions 53 protruding upward are formed on an upper surface side of the main body portion 52. In the embodiment, five protruding portions 53 having the outer shape of a substantially rectangular shape are aligned in the left-right direction. The protruding portions 53 can pass through the respective through holes 35b provided in the front door portion 35 (see FIGS. 3 and 7). An upper surface 53a of each of the protruding portions 53 is substantially flush with an upper surface of the front door portion 35. The main body portion 52 radiates visible light from the light source portion 55 (light guide 58) from the upper surface 53a side of the protruding portion 53 while further diffusing the visible light inside. The main body portion 52 is formed of a synthetic resin such as a polycarbonate resin or an acrylic resin.

The light source portion 55 includes the substrate 56, visible light sources (visible light LEDs) 57 attached to the substrate 56, and the light guide 58 stacked on the substrate 56. The visible light sources (visible light LEDs) 57 can emit visible light when turned on. The light guide 58 is disposed on a lower surface side of the main body portion 52. An outer shape of the substrate 56 is set larger than that of the light guide 58 so as to cover substantially the entire area under the light guide 58. In the case of the embodiment, the visible light sources (visible light LEDs) 57 are aligned, on a front edge side of the substrate 56 (in front of the light guide body 58), at five locations corresponding to the respective protruding portions 53 of the main body portion 52 (see FIGS. 3 and 6). In the case of the embodiment, as the visible light source, the full-color visible light LED 57 that can change color by sealing, in one package, light sources that can emit red light, green light, and blue light and changing the brightness of each light source is used. These visible light LEDs 57 are electrically connected to the control device 65 provided on the vehicle body side via the lead wire 62 connected to a back surface side of the substrate 56. Each of the visible light LEDs 57 can be turned on so as to emit visible light in a predetermined color in response to an operation signal from the control device 65.

The holding member 60 is a member that can cover the entire lower surface side of the substrate 56 in the light source unit 55 and holds the substrate 56 (light source unit 55). A connector attachment portion 60a that partially protrudes downward is formed at a position that is a center of the holding member 60 in the left-right direction (see FIGS. 6 and 7). The connector attachment portion 60a is a portion for attaching a connector 63 provided on one end side of the lead wire 62 and connecting the lead wire 62.

The decorative body 50 is attached to the front door portion 35 in a state where predetermined portions are locked and the main body portion 52, the light source portion 55, and the holding member 60 are stacked and integrated. Specifically, the decorative body 50 is disposed on the back surface side of the front door portion 35 so as to allow the coupling protrusions 35c extending from the front door 35 portion to pass through, and is attached to the front door portion 35 by melting the tip end side of the coupling protrusions 35c on a lower surface side of the holding member 60 (see FIG. 7). The lead wire 62 extending from the connector attachment portion 60a (that is, the back surface side of the disposition area of the decorative body 50 in the front door portion 35) provided on the back surface side of the decorative body 50 and passing through the back surface side of the ceiling wall portion 31 is inserted into the slit 42 formed in the front portion 40a of the peripheral wall portion 40 of the pad 30. At this time, the connector 64 on the other end side (tip end 62a side) of the lead wire 62 protrudes to the outside of the pad 30. The lead wire 62 protruding from the pad 30 is disposed on the lower surface side of the bag holder 20 (bottom wall portion 21) such that the connector 64 provided on the tip end 62a side is locked to the locking protruding piece 25 protruding downward from the bottom wall portion 21 of the bag holder 20 (see FIGS. 4 to 6).

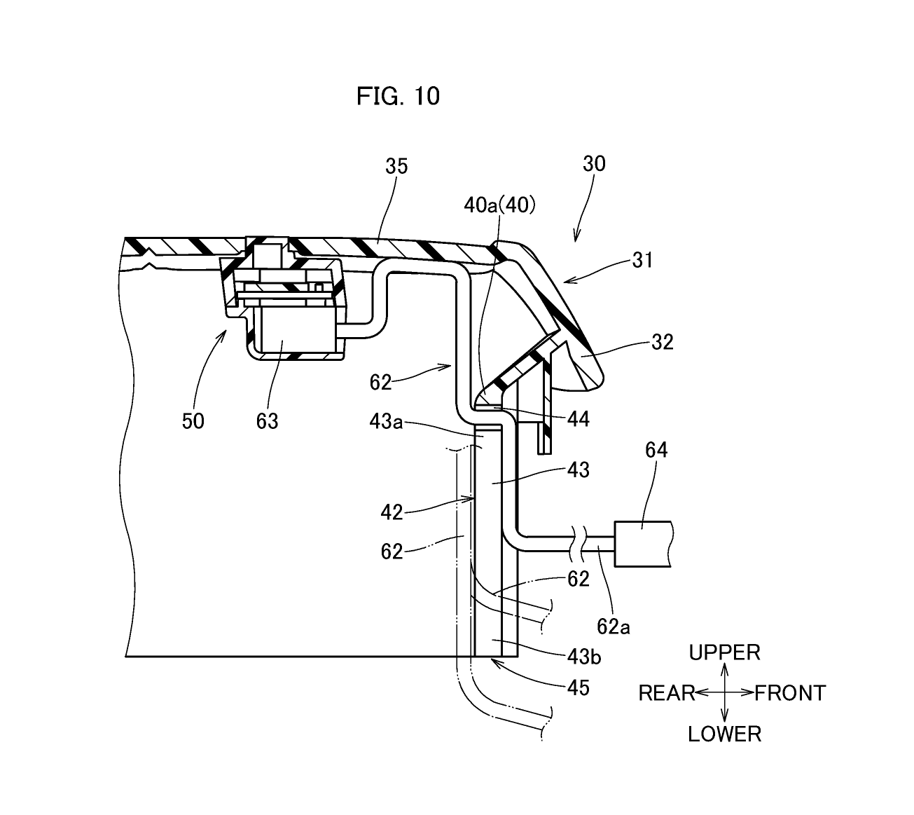

Next, mounting of the steering wheel 1 of the embodiment on a vehicle will be described. In the pad 30 to which the decorative body 50 is attached, the lead wire 62 extending from the back surface side of the decorative body 50 (the back surface side of the front door portion 35) passes through the back surface side of the ceiling wall portion 31, is inserted into the general portion 43 of the slit 42 provided in the front portion 40a of the peripheral wall portion 40 through the opening 45 at the lower end 43b, and protrudes to the outside from the round hole portion 44 on the upper end 43a side (see FIG. 10). Then, the pad 30 is attached to the bag holder 20 in a state where the folded airbag 16 and the inflator 17 are attached so as to cover the periphery of the folded airbag 16. In this manner, the airbag device 15 can be assembled. The lead wire 62 protruding to the outside of the pad 30 is inserted into the insertion recess 24 formed in the bag holder 20, and the connector 64 on the tip end 62a side is locked to the locking protruding piece 25 formed on the bottom wall portion 21. Thereafter, the airbag device 15 is attached, using a horn switch unit (not illustrated), to the steering wheel body 7 in a state of being attached to the vehicle body side. The lead wire 62 extending from the decorative body 50 is connected to a lead wire (not illustrated) extending from the control device 65. The inflator 17 is electrically connected to the control device 65. In this manner, the airbag device 15 can be assembled to the steering wheel body 7, and the steering wheel 1 can be mounted on the vehicle.

Further, in the steering wheel 1 (steering device) of the embodiment, the slit 42 is provided in the peripheral wall portion 40 of the pad 30, and even when the decorative body 50 serving as an electronic component is configured to be installed on the pad 30, the lead wire 62 disposed so as to extend from the decorative body 50 and pass through the back surface side of the pad 30 is configured to protrude to the outside of the pad 30 through the slit 42. The slit 42 is formed by cutting out the peripheral wall portion 40 from the tip end side (lower end side) so that the lead wire 62 can be inserted. Therefore, even in a case where the lead wire 62 is configured to have the connector 64 on the tip end 62a side, if the lead wire 62 is inserted into the slit 42 through the opening 45 provided on the tip end side (lower end side, that is, the lower end 43b side of the general portion 43) of the peripheral wall portion 40, the tip end 62a side where the connector 64 is provided in the lead wire 62 can protrude to the outside of the pad 30 (see FIG. 10). As a result, as compared with the case where an insertion opening is provided by cutting out a peripheral wall portion like the conventional steering device, the work of protruding the lead wire 62 to the outside of the pad 30 (the work of passing through the peripheral wall portion 40) is easy, and the workability is good.

Therefore, the steering wheel 1 (steering device) of the embodiment has good workability and can be easily assembled.

In the steering wheel 1 of the embodiment, the slit 42 may have an opening width dimension through which the lead wire 62 alone can be inserted (the connector 64 provided on the tip end 62a side of the lead wire 62 cannot be inserted). Therefore, the opening width dimension of the slit 42 can be set as small as possible. In the steering wheel 1 of the embodiment, two door portions (front door portion 35, rear door portion 36) that open when the airbag 16 is deployed and inflated are arranged on the ceiling wall portion 31 of the pad 30. Therefore, in order to smoothly open the front door portion 35 and the rear door portion 36, it is necessary to secure the strength of the area (the peripheral wall portion 40 and the like) around the ceiling wall portion 31 to some extent. In the steering wheel 1 of the embodiment, since the opening width dimension of the slit 42 can be set as small as possible, it is easy to maintain the strength of the peripheral wall portion 40 and the area around the peripheral wall portion 40. It is also possible to prevent the peripheral wall portion from being thicker than necessary. In the embodiment, the slit 42 is formed over substantially the entire area in the upper-lower direction of the peripheral wall portion 40 so that the round hole portion 44 on the upper end side is positioned in the vicinity of the ceiling wall portion 31. However, the depth (length dimension) of the slit is not limited to the embodiment. For example, the slit may be provided only in an area of about a lower half of the peripheral wall portion or an area on a lower end (tip end) side.

Further, in the steering wheel 1 of the embodiment, the slit 42 is provided in the peripheral wall portion 40 at a position (area of the front portion 40a) in the vicinity of the side serving as the hinge of the front door portion 35, on which the decorative body 50 is installed, when the front door portion 35 is opened. Therefore, the amount (length) of the lead wire 62 passing through the inside of the pad 30 (the back surface side of the ceiling wall portion 31) can be set to the minimum, and the lead wire 62 can be prevented from affecting the inflating airbag 16. If such a point is not taken into consideration, the slit may be provided in an area (for example, in the peripheral wall portion, an area covering the rear side of the folded airbag or an area covering the left or right side of the folded airbag) deviated from the above-described area, and the lead wire may be disposed so as to extend relatively long on the back surface side of the ceiling wall portion.

Further, in the steering wheel 1 of the embodiment, the slit 42 is provided with the retaining portions 42a that can prevent the lead wire 62 inserted therein from coming off. Specifically, in the steering wheel 1 of the embodiment, the slit 42 includes the general portion 43 cut out in a groove shape and the round hole portion 44 formed to bulge from the general portion 43 on the upper end 43a side of the general portion 43 (keyhole shape). The area of the peripheral edge of the general portion 43 in the vicinity of the round hole portion 44 constitutes the retaining portions 42a and 42a that can prevent the lead wire 62 inserted into the round hole portion 44 from coming off (re-entering into the general portion 43) (see FIG. 9). Therefore, in the steering wheel 1 of the embodiment, the lead wire 62 once inserted into the round hole portion 44 can be prevented from re-entering the general portion 43 (separation from the round hole portion 44 can be suppressed), and the state in which the lead wire 62 is inserted into the slit 42 can be maintained. As a result, workability at the time of subsequent work (at the time of attachment work of the pad 30 to the bag holder 20) and the like is improved. If such a point is not taken into consideration, the slit may not be provided with a retaining portion that can prevent the lead wire from coming off.

Although the slit has a keyhole shape in the embodiment, the shape of the slit is not limited to the embodiment even when the retaining portion is provided. For example, the slit simply formed in the groove shape may be configured such that the opening width dimension is set to be equal to the outer diameter dimension or the width dimension of the lead wire, and the lead wire can be inserted, but the slide movement inside is difficult, and the inner peripheral surface itself of the slit may be used as the retaining portion (using the frictional force generated between the inner peripheral surface of the slit and the lead wire). Although not illustrated in detail, a protruding portion that slightly protrudes inward may be provided as the slit at an intermediate portion of the groove-shaped slit, and the protruding portion may be used as a retaining portion. In the embodiment, the width dimension of the general portion 43 of the slit 42 is made constant toward the opening 45 on the lower end 43b side. However, the shape of the slit is not limited to the embodiment. For example, although not illustrated in detail, the slit may be formed such that the general portion has a wide opening width dimension in the area on the tip end side (lower end side). With such a configuration, the opening portion on the lower end side can be opened wide, and the work of inserting the lead wire into the slit is further facilitated.

In the steering wheel 1 of the embodiment, the decorative body 50 that emits light at a predetermined time is installed as an electronic component disposed on the pad 30. However, the electronic component is not limited to the decorative body. The present disclosure is also applicable to, for example, a steering device having a configuration in which a display, a camera for monitoring a driver, or the like is mounted on a pad as an electronic component.

The present disclosure relates to a steering device having the following configuration.

A steering device of the present disclosure includes:

a pad disposed on an upper side of a boss portion;

an electronic component disposed on the pad and electrically connected to a control device provided on a vehicle body side, in which

the pad includes a ceiling wall portion disposed on a driver side and a peripheral wall portion extending in a tubular shape from an area near a peripheral edge of the ceiling wall portion, and

in the peripheral wall portion, a slit that allows a lead wire to be inserted is formed by cutting out the peripheral wall portion from a tip end side, the lead wire extending from a disposition area of the electronic component in the ceiling wall portion and passing through a back surface side of the ceiling wall portion.

In the steering device of the present disclosure, the slit is provided in the peripheral wall portion of the pad, and even when the electronic component is configured to be installed on the pad, the lead wire disposed so as to extend from the electronic component and pass through the back surface side of the pad protrudes to the outside of the pad through the slit. The slit is formed by cutting out the peripheral wall portion from the tip end side so that the lead wire can be inserted. Therefore, even in a case where the lead wire is configured to have the connector on the tip end side, if the lead wire is inserted into the slit through the opening provided on the tip end side of the peripheral wall portion, the tip end side where the connector is provided in the lead wire can protrude to the outside of the pad. As a result, as compared with the case where an insertion opening is provided by cutting out a peripheral wall portion like the conventional steering device, the work of protruding the lead wire to the outside of the pad (the work of passing through the peripheral wall portion) is easy, and the workability is good.

Therefore, the steering device of the present disclosure has good workability and can be easily assembled.

Further, in the steering device of the present disclosure, the slit may have an opening width dimension through which the lead wire alone can be inserted. Therefore, the opening width dimension of the slit can be set as small as possible.

Furthermore, in the steering device of the present disclosure, it is preferable that the pad is configured to be able to cover a folded airbag, and a plurality of door portions that are openable when the airbag is deployed and inflated are arranged in an area of the ceiling wall portion, and

the slit is provided in the peripheral wall portion at a position in the vicinity of a side serving as a hinge of one of the door portions, on which the electronic component is installed, when the door portion are opened.

With the above configuration of the steering device, the length (disposition area) of the lead wire passing through the inside of the pad (the back surface side of the ceiling wall portion) can be set to the minimum, and the lead wire can be prevented from affecting the inflated airbag.

Further, in the steering device having the above configuration, it is preferable that the slit is provided with a retaining portion that can prevent the lead wire inserted therein from coming off. With such a configuration, it is possible to suppress detachment, from the slit, of the lead wire once inserted into the slit and to maintain the state in which the lead wire is inserted into the slit. As a result, workability at the time of subsequent work (at the time of attachment work of the pad to the bag holder) and the like is improved.

What is claimed is:

1. A steering device comprising:
a pad disposed on an upper side of a boss portion;
an electronic component disposed on the pad and electrically connected to a control device provided on a vehicle body side, wherein
the pad includes a ceiling wall portion disposed on a driver side and a peripheral wall portion extending in a tubular shape from an area near a peripheral edge of the ceiling wall portion, and
in the peripheral wall portion, a slit that allows a lead wire to be inserted is formed by cutting out the peripheral wall portion from a tip end side, the lead wire extending from a disposition area of the electronic component in the ceiling wall portion and passing through a back surface side of the ceiling wall portion.

2. The steering device according to claim 1, including a folded airbag, wherein
the pad is configured to be able to cover the folded airbag, and a plurality of door portions that are openable when the airbag is deployed and inflated are arranged in an area of the ceiling wall portion, and
the slit is provided in the peripheral wall portion at a position in a vicinity of a side serving as a hinge of one of the door portions, on which the electronic component is installed, when the door portion is opened.

3. The steering device according to claim 1, wherein
the slit has a retaining portion capable of preventing the lead wire inserted into the slit from coming off.

4. The steering device according to claim 3, wherein
the slit includes a general portion formed by cutting out the peripheral wall portion in a groove shape, and a round hole portion formed so as to bulge from the general portion on an end portion side of the general portion on a ceiling wall portion side, and
an area of a peripheral edge of the general portion in a vicinity of the round hole portion constitutes the retaining portion.

5. The steering device according to claim 4, wherein
the round hole portion is disposed in a vicinity of the ceiling wall portion.

6. The steering device according to claim 1, wherein
the electronic component is a decorative body disposed on the ceiling wall portion and configured to emit light at a predetermined time.
